(19) United States
(12) Patent Application Publication
(10) Pub. No.: US 2024/0202634 A1
(43) Pub. Date: Jun. 20, 2024

(54) DIALOGUE TRAINING DEVICE, DIALOGUE TRAINING SYSTEM, DIALOGUE TRAINING METHOD, AND COMPUTER-READABLE MEDIUM

(71) Applicants: Jun NAKAGAWA, Kanagawa (JP); Haruhiko YASUDA, Tokyo (JP)

(72) Inventors: Jun NAKAGAWA, Kanagawa (JP); Haruhiko YASUDA, Tokyo (JP)

(21) Appl. No.: 18/536,267

(22) Filed: Dec. 12, 2023

(30) Foreign Application Priority Data
Dec. 14, 2022 (JP) 2022-199578

(51) Int. Cl. G06Q 10/0639; G06V 40/16; G06V 40/20; G10L 15/08; G10L 15/26; G10L 25/63; H04N 7/15

(52) U.S. Cl. CPC G06Q 10/0639; G06V 40/174; G06V 40/20; G10L 15/08; G10L 15/26; G10L 25/63; H04N 7/157

(57) ABSTRACT

A dialogue training device includes an obtaining unit and a first analyzing unit. The obtaining unit is configured to, during a dialogue in which a voice of an answer to voice data of an utterance made by a user is output using a video of a virtual person generated based on information related to a target person assumed to conduct the dialogue, obtain the voice data and video data of the user input into a terminal device. The first analyzing unit is configured to, based on the voice data and the video data obtained by the obtaining unit, analyze a dialogue skill with the virtual person.

### CROSS-REFERENCE TO RELATED APPLICATION

The present application claims priority under 35 U.S.C. § 119 to Japanese Patent Application No. 2022-199578, filed on Dec. 14, 2022. The contents of which are incorporated herein by reference in their entirety.

### BACKGROUND OF THE INVENTION

### 1. Field of the Invention

The present invention relates to a dialogue training device, a dialogue training system, a dialogue training method, and a computer-readable medium.

### 2. Description of the Related Art

In recent years, in the business environment that is undergoing significant changes termed as VUCA (which stands for volatility uncertainty complexity ambiguity), a business enterprise finds it difficult to implement top-down management, and each individual employee is required to autonomously do the tasks of agenda setting and operation execution. Moreover, each employee is expected to proactively make sense of the work and grasp the scope of responsibility, and is expected to take a stance of autonomously designing one's own career. On the other hand, as far as the actual conditions at a workplace are concerned, due to the segmentation of the tasks, the agendas and the topics to be addressed are often small, or often the prerequisite for the agendas change quickly. If that results in nurturing a climate in which one feels that all diligent work goes unrequited in the company, then it may lead to a decline in the engagement toward the workplace. In such a situation, the workplace is expected to deal with such contemporary workplace issues by periodically carrying out 1-on-1 interactive meetings between a superior and a subordinate.

As a dialogue management technology designed for managing the dialogue in regard to conferences or meetings, with the aim of enhancing the productivity of a meeting, a configuration is disclosed that includes: a reference information storing unit that is used to store, for each objective of a meeting, reference information meant for determining the state of the meeting based on the utterances made during the meeting; an objective information obtaining unit that obtains objective information indicating the objective of a specific meeting; an utterance information obtaining unit that obtains utterance information indicating the utterances made during the specific meeting; a meeting state determining unit that determines the state of the specific meeting based on the utterance information and based on the reference information corresponding to the objective information; and an output unit that, based on the determination result about the state of the specific meeting, performs output according to the state of the specific meeting (for example, refer to Japanese Unexamined Patent Application Publication No. 2018-200541).

However, in regard to the technology disclosed in Japanese Unexamined Patent Application Publication No. 2018-200541, obtaining the data such as the utterance details leads to a privacy issue, it is not possible to analyze the dialogue skills based on the in-depth details of the dialogue.

### SUMMARY OF THE INVENTION

According to an aspect of the present invention, a dialogue training device includes an obtaining unit and a first analyzing unit. The obtaining unit is configured to, during a dialogue in which a voice of an answer to voice data of an utterance made by a user is output using a video of a virtual person generated based on information related to a target person assumed to conduct the dialogue, obtain the voice data and video data of the user input into a terminal device. The first analyzing unit is configured to, based on the voice data and the video data obtained by the obtaining unit, analyze a dialogue skill with the virtual person.

### BRIEF DESCRIPTION OF THE DRAWINGS

FIG. 1 is a diagram illustrating an exemplary overall configuration of a dialogue training system according to an embodiment;

FIG. 2 is a diagram for explaining the usage state of a user terminal during a dialogue training taken using the dialogue training system according to the embodiment;

FIG. 3 is a diagram illustrating an exemplary hardware configuration of the user terminal according to the embodiment;

FIG. 4 is a diagram illustrating an exemplary hardware configuration of various devices of a server system according to the embodiment;

FIG. 5 is a diagram illustrating an exemplary configuration of the functional blocks of the dialogue training system according to the embodiment;

FIG. 6 is a diagram illustrating an example of the association between the emotions of the user and the reactions of a virtual person;

FIGS. 7 and 8 are diagrams for explaining the operations performed in a dialogue skill analysis device according to the embodiment;

FIG. 9 is a sequence diagram illustrating an exemplary flow of operations performed for determining the video model of the virtual person in the dialogue training system according to the embodiment;

FIG. 10 is a sequence diagram illustrating an exemplary flow of operations performed for generating the voice of the virtual person in the dialogue training system according to the embodiment;

FIG. 11 is a sequence diagram illustrating an exemplary flow of operations performed for deciding on the personality model of the virtual person in the dialogue training system according to the embodiment;

FIG. 12 is a sequence diagram illustrating an exemplary flow of operations performed for taking the dialogue training by conducting a dialogue with the virtual person in the dialogue training system according to the embodiment; and

FIG. 13 is a flowchart for explaining an exemplary flow of an analysis operation performed for analyzing the emotion data in the dialogue skill analysis device according to the embodiment.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An embodiment has an object to provide a dialogue training device, a dialogue training system, a dialogue training method, and a computer-readable medium that enable analyzing the dialogue skill regardless of the details of the dialogue and without having to give extra consideration to the privacy.

An exemplary embodiment of a dialogue training device, a dialogue training system, a dialogue training method, and a computer program product according to the present invention is described below in detail with reference to the accompanying drawings. However, the present invention is not limited to the embodiment described below and is to be construed as embodying all modifications such as other embodiments, additions, alternative constructions, and deletions that may occur to one skilled in the art that fairly fall within the basic teaching herein set forth.

Herein, computer software implies the computer programs used in the operation of a computer and implies the information that is provided for enabling processing performed in a computer and that is based on the computer programs (hereinafter, computer software is referred to as software). Moreover, application software implies the generic term used for the software that, from among the types of software, is used for carrying out particular tasks. An operating system (OS) implies the software meant for controlling a computer and enabling the application software to use the computer resources. The operating system performs basic management/control of the computer such as input-output control, hardware management of the memory and the hard disk, and process management. An application software runs by using the functions provided by the operating system. A computer program implies a set of commands written for enabling the computer to obtain a particular result. Moreover, the information based on computer programs cannot be termed as a computer program because it does not include direct commands for a computer, but has similar qualities to a computer program in terms of specifying the processing to be performed in a computer. For example, a data structure (a logical structure of data that is expressed using correlation among data elements) is equivalent to the information based on computer programs.

### Overall Configuration of Dialogue Training System

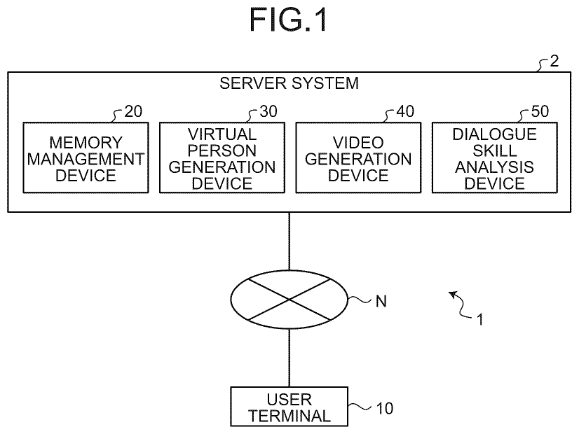

FIG. 1 is a diagram illustrating an exemplary overall configuration of a dialogue training system according to the embodiment. Thus, explained below with reference to FIG. 1 is the overall configuration of a dialogue training system 1 according to the embodiment.

The dialogue training system 1 illustrated in FIG. 1 can automatically generate a video, a voice, and utterance details of a virtual person not existing in reality, and enables the user to make a quasi-dialogue with the virtual person; and at the same time can obtain the utterance details and the behavior of the user during the dialogue as data, analyze the dialogue skills of the user, and carry out dialogue training by giving feedback on the analysis result about the dialogue skills to the user after the end of the dialogue. Examples of the scenario in which two persons undergo dialogue training using the dialogue training system 1 include a 1-on-1 meeting between a superior and a subordinate, a dialogue between a senior and a junior, a dialogue between a teacher and a student, and a dialogue between a test proctor and a test subject.

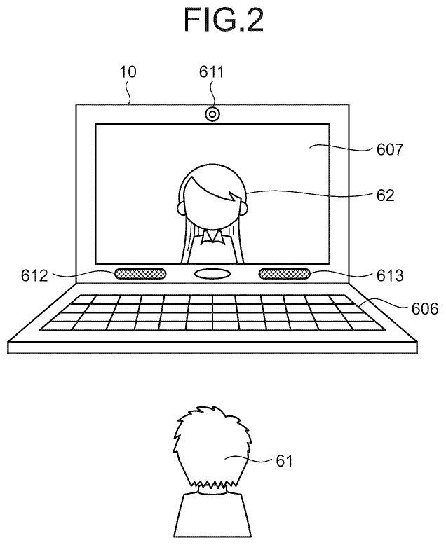

As illustrated in FIGS. 1 and 2, a user 61 uses a user terminal 10 to conduct a dialogue with a virtual person 62 displayed in a display device 607, and is able to receive feedback on the analysis result about the dialogue skills. Herein, the user 61 is a superior who is taking dialogue training using the dialogue training system 1. The virtual person 62 is a virtual person for whom a video and a voice are generated on the assumption that the virtual person is a subordinate or the like with whom the user 61 is planning to have an actual dialogue. As illustrated in FIG. 2, the user terminal 10 includes an input device 606 meant for performing an input operation; a microphone 612 meant for receiving input of the voice of the user 61; a speaker 613 meant for outputting the voice of the virtual person 62; the display device 607 meant for displaying a video of the virtual person 62; and a camera 611 meant for taking images of the user 61.

As illustrated in FIG. 1, the dialogue training system 1 includes a server system 2 and a user terminal 10 (a terminal device). Moreover, as illustrated in FIG. 1, the server system 2 includes a memory management device 20, a virtual person generation device 30 (a first generation device), a video generation device 40 (a second generation device), and a dialogue skill analysis device 50 (a dialogue training device).

The user terminal 10, the memory management device 20, the virtual person generation device 30, the video generation device 40, and the dialogue skill analysis device 50 are connected to each other via a network N in a data-communicable manner. Herein, the data communication can be wireless communication or wired communication.

The user terminal 10 is an information processing device such as a personal computer (PC), a smartphone, or a tablet terminal used by a user who is taking the dialogue training.

Meanwhile, the user terminal 10 can be a planar reproduction device such as a liquid crystal screen, or can be a head-mounted display type virtual reality (VR) display device or a hologram (stereoscopic video) display device that stereoscopically reproduces an image of a virtual person. In this way, when the user terminal 10 stereoscopically reproduces an image of a virtual person, a dialogue with the virtual person can have a greater sense of reality. Alternatively, the user terminal 10 can be a projector device using which a plurality of users can simultaneously view the same image of a virtual person. Meanwhile, there can be one or more user terminals 10 that communicate with the server system 2. In the following explanation, the user terminal 10 is assumed to be a PC.

The memory management device 20 is used to store and manage information such as video models of virtual persons, personality models of virtual persons, and voices of virtual persons.

The virtual person generation device 30 is an information processing device that generates information regarding the video, the personality, and the voice of a virtual person (hereinafter, the information is sometimes referred to as virtual person data).

The video generation device 40 is an information processing device that uses a set of virtual person data generated by the virtual person generation device 30, and generates a video of a virtual person.

The dialogue skill analysis device 50 is an information processing device that analyzes the dialogue skills of the user, who is undergoing the dialogue training using the dialogue training system 1, based on the video data and the voice data input in the user terminal 10.

Meanwhile, either the entire server system 2 can be configured using a single server device (an information processing device), or at least two or more devices from among the memory management device 20, the virtual person generation device 30, the video generation device 40, and the dialogue skill analysis device 50 can be configured using a single server device. Alternatively, from among the memory management device 20, the virtual person generation device 30, the video generation device 40, and the dialogue skill analysis device 50 of the server system 2, one or more devices can be implemented using a cloud system.

### Hardware Configuration of User Terminal

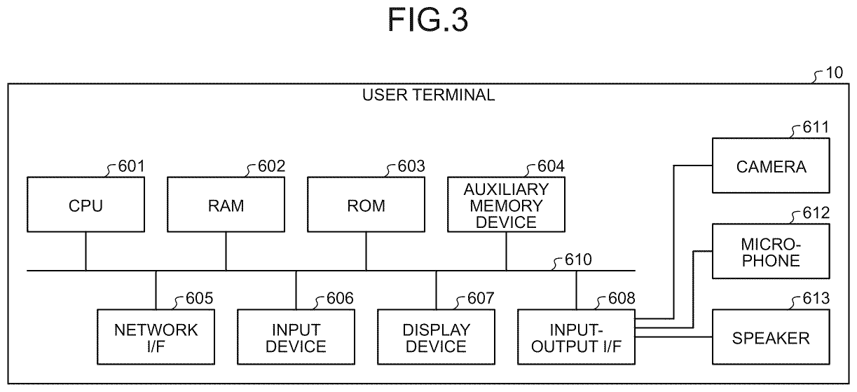

FIG. 3 is a diagram illustrating an exemplary hardware configuration of the user terminal according to the embodiment. Thus, explained below with reference to FIG. 3 is a hardware configuration of the user terminal 10 according to the present embodiment.

As illustrated in FIG. 3, the user terminal 10 includes a central processing unit (CPU) 601, a random access memory (RAM) 602, a read only memory (ROM) 603, an auxiliary memory device 604, a network interface (I/F) 605, an input device 606, a display device 607, an input-output I/F 608, a camera 611, a microphone 612, and a speaker 613. From among them, the CPU 601, the RAM 602, the ROM 603, the auxiliary memory device 604, the network I/F 605, the input device 606, the display device 607, and the input-output I/F 608 are connected to each other via a bus 610 in a data-communicable manner.

The CPU 601 is an arithmetic device that controls the operations of the entire user terminal 10 and performs a variety of information processing. The CPU 601 executes computer programs stored in the ROM 603 or the auxiliary memory device 604.

The RAM 602 is used as the work area for the CPU 601 and is a volatile memory device used to store main control parameters and information. The ROM 603 is a nonvolatile memory device used to store a basic input-output program.

The auxiliary memory device 604 is a nonvolatile memory device such as a hard disk drive (HDD) or a solid state drive (SSD). The auxiliary memory device 604 is used to store, for example, computer programs meant for controlling the operations of the user terminal 10 and a variety of data and files required in the operations of the user terminal 10.

The network I/F 605 is a communication interface that enables communication with the devices, such as the devices of the server system 2, present in a network. The network I/F 605 is implemented using, for example, a network interface card (NIC) compatible to the TCP/IP (which stands for Transmission Control Protocol/Internet Protocol).

The input device 606 is a user interface such as a keyboard, a mouse, or operation buttons. The display device 607 is used to display a variety of information.

The display device 607 is implemented using, for example, a liquid crystal display (LCD) or organic electro-luminescence (EL).

The input-output I/F 608 is an interface meant for establishing connection with various input-output devices.

The camera 611 is an imaging device that takes images of the user who is undergoing the dialogue training using the dialogue training system 1. The microphone 612 is a sound collecting device that collects the sounds uttered by the user who is undergoing the dialogue training using the dialogue training system 1. The speaker 613 is an output device that outputs the voice of the virtual person having a dialogue with the user who is undergoing the dialogue training using the dialogue training system 1. Meanwhile, the camera 611, the microphone 612, and the speaker 613 either can be internal devices or can be external devices.

The hardware configuration of the user terminal 10 as illustrated in FIG. 3 is only exemplary, and other devices can also be included. Moreover, although the user terminal 10 illustrated in FIG. 3 has the hardware configuration of, for example, a personal computer (PC), that is not the only possible case. Alternatively, the user terminal 10 can have the hardware configuration of a smartphone or a tablet terminal as mentioned earlier. In that case, the network I/F 605 can be a wireless interface equipped with the wireless communication function.

### Hardware Configuration of Server System

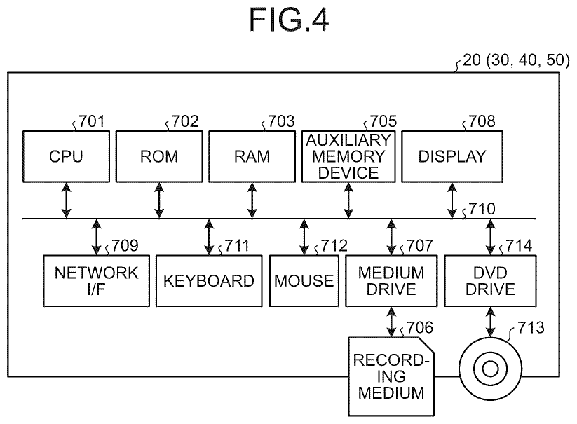

FIG. 4 is a diagram illustrating an exemplary hardware configuration of various devices of the server system according to the embodiment. Thus, explained below with reference to FIG. 4 is the hardware configuration of the devices of the server system 2 (i.e., the memory management device 20, the virtual person generation device 30, the video generation device 40, and the dialogue skill analysis device 50). With reference to FIG. 4, the explanation is given about the memory management device 20 as an example. However, the virtual person generation device 30, the video generation device 40, and the dialogue skill analysis device 50 also have an identical configuration.

As illustrated in FIG. 4, the memory management device 20 includes a CPU 701, a ROM 702, a RAM 703, an auxiliary memory device 705, a medium drive 707, a display 708, a network I/F 709, a keyboard 711, a mouse 712, and a digital versatile disk (DVD) drive 714.

The CPU 701 is an arithmetic device that controls the operations of the entire memory management device 20. The ROM 702 is a nonvolatile memory device used to store the computer programs written for the memory management device 20. The RAM 703 is a volatile memory device used as the work area for the CPU 701.

The auxiliary memory device 705 is a memory device such as a hard disk drive (HDD) or a solid state drive (SSD) used to store a variety of data and computer programs.

The medium drive 707 is a device that, under the control of the CPU 701, performs control for reading and writing of data with respect to a recording medium 706 such as a flash memory.

The display 708 is a display device configured using liquid crystals or organic EL and is used to display a variety of information such as a cursor, menus, windows, characters, and images.

The network I/F 709 is an interface for enabling communication of data among the virtual person generation device 30, the video generation device 40, and the dialogue skill analysis device 50 via the network N. The network I/F 709 corresponds to, for example, the ethernet (registered trademark) and is implemented using a network interface card (NIC) compatible to the TCP/IP. Alternatively, the network I/F 709 can be an interface for performing wireless communication with other devices via an antenna and according to a standard such as Wi-Fi (registered trademark), 4G, or 5G.

The keyboard 711 is an input device used to input characters, to input numerical characters, to select various instructions, and to move the cursor. The mouse 712 is an input device used to select and execute various instructions, to select the processing target, and to move the cursor.

The DVD drive 714 controls the reading and writing of data with respect to a DVD 713 that is a DVD-ROM (which stands for Digital Versatile Disk Read Only Memory) or a DVD-R (which stands for Digital Versatile Disk Recordable) representing an example of a detachably-attachable memory medium.

The CPU 701, the ROM 702, the RAM 703, the auxiliary memory device 705, the medium drive 707, the display 708, the network I/F 709, the keyboard 711, the mouse 712, and the DVD drive 714 are connected to each other via a bus 710, such as an address bus or a data bus, in a data-communicable manner.

Meanwhile, the hardware configuration of the memory management device 20 as illustrated in FIG. 4 is only exemplary. That is, it is not necessary to include all of the constituent elements illustrated in FIG. 4, and it is also possible to add other constituent elements.

### Configuration and Operations of Functional Blocks of Dialogue Training System

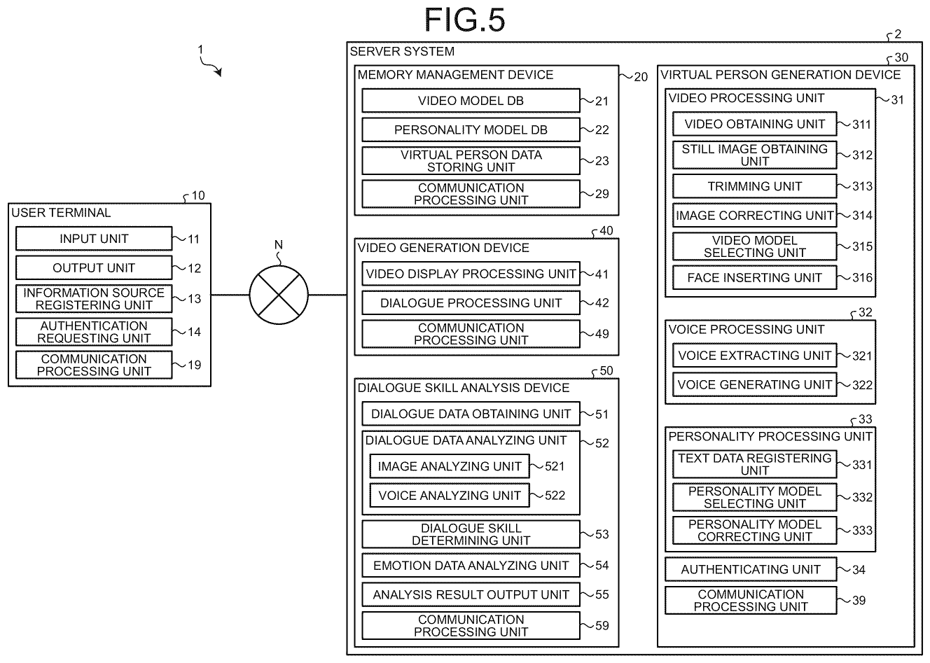

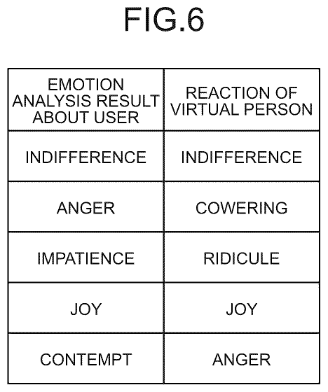

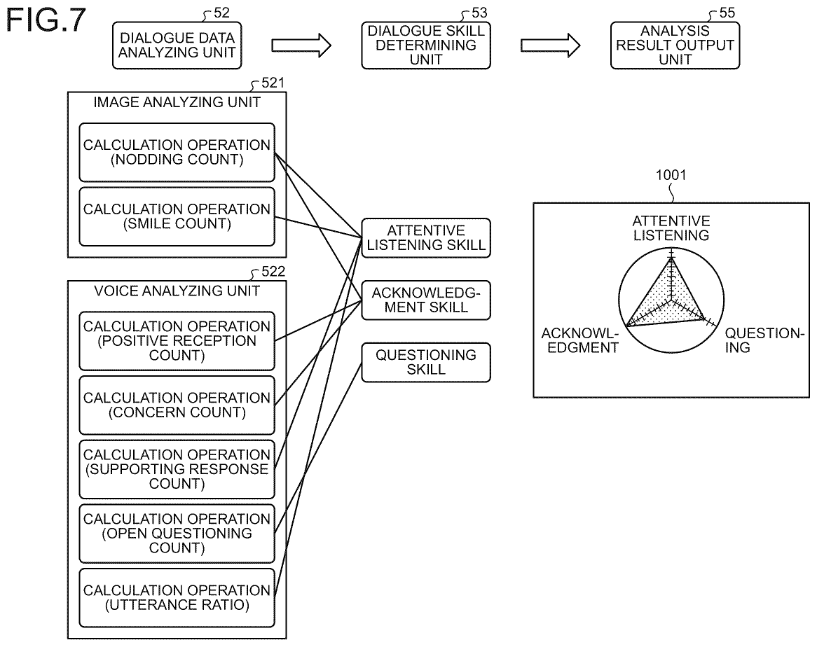

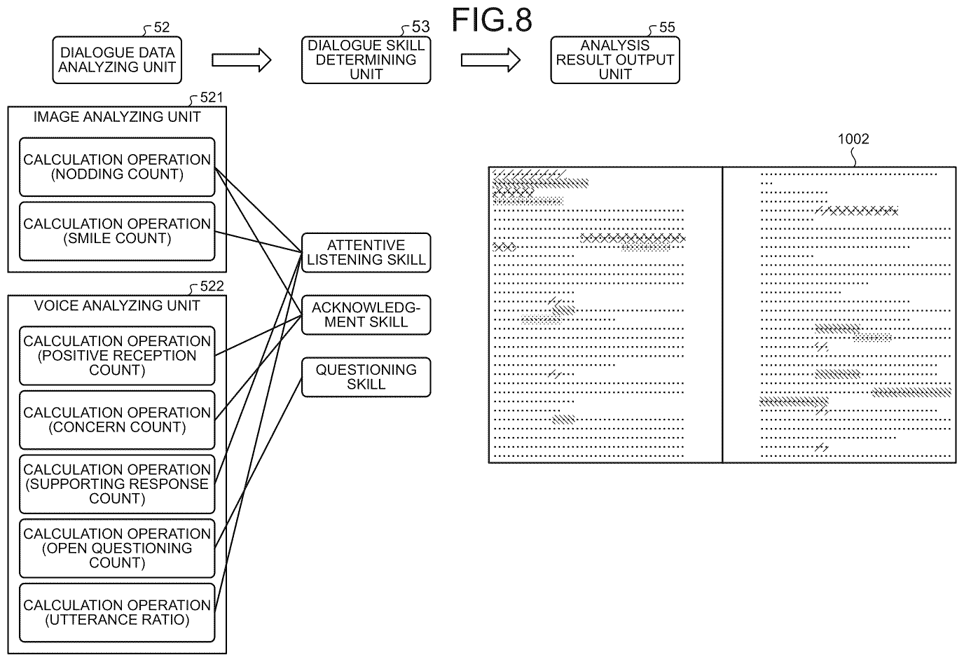

FIG. 5 is a diagram illustrating an exemplary configuration of the functional blocks of the dialogue training system according to the embodiment. FIG. 6 is a diagram illustrating an example of the association between the emotions of the user and the reactions of the virtual person. FIGS. 7 and 8 are diagrams for explaining the operations performed in the dialogue skill analysis device according to the embodiment. Thus, explained below with reference to FIGS. 5 to 8 is the configuration and the operations of the functional blocks of the dialogue training system according to the present embodiment.

### Configuration and Operations of Functional Blocks of User Terminal

As illustrated in FIG. 5, the user terminal 10 includes an input unit 11, an output unit 12, an information source registering unit 13, an authentication requesting unit 14, and a communication processing unit 19.

The input unit 11 is a functional unit that obtains (receives input of) video data as a result of taking images of the face of the user; receives input of the voice uttered by the user; and receives an operation input from the user. The input unit 11 is implemented using the input device 606, the camera 611, and the microphone 612 illustrated in FIG. 3.

The output unit 12 is a functional unit that displays the video of the virtual person as generated by the video generation device 40, and outputs the voice of that video. The output unit 12 is implemented using the display device 607 and the speaker 613 illustrated in FIG. 3.

The information source registering unit 13 is a functional unit that obtains information which serves as a model for the virtual person and which is related to the target person assumed to conduct dialogue (for example, a subordinate) (hereinafter, the information is sometimes referred to as the information source); and registers the obtained information in the auxiliary memory device 604. That is, the virtual person is a hypothetical person mapped to the target person. Herein, the information source implies information about the target person that contains, for example, at least one of the following: videos, still images, and audio sources in which the target person is captured; records such as diaries crated by the target person; documents indicating the hobbies and diversions; character data found in the social networking service (SNS); and information related to the belongings of the target person. Meanwhile, the information source registering unit 13 either can obtain, as the information source, the information that is input by operating the input unit 11, or can obtain the information source from external devices via the Internet. The information source registering unit 13 sends the registered information source to the virtual person generation device 30 via the communication processing unit 19 at an appropriate timing. The information source registering unit 13 is implemented when the CPU 601 illustrated in FIG. 3 executes a computer program.

The authentication requesting unit 14 is a functional unit that, at the time when the user uses the dialogue training system 1, requests for login authentication with respect to the virtual person generation device 30. The authentication requesting unit 14 is implemented when the CPU 601 illustrated in FIG. 3 executes a computer program.

The communication processing unit 19 is a functional unit that performs data communication with the server system 2 via the network N. The communication processing unit 19 is implemented using the network I/F 605, which is illustrated in FIG. 3, when the CPU 601 executes a computer program.

Meanwhile, the functional units such as the information source registering unit 13 and the authentication requesting unit 14 can be partially or entirely implemented using a hardware circuit (an integrated circuit), such as a field-programmable gate array (FPGA) or an application specific integrated circuit (ASIC), instead of using computer programs representing software.

Moreover, the functional units of the user terminal 10 as illustrated in FIG. 5 are merely conceptual and are not limited to the configuration explained above. Alternatively, for example, a plurality of functional units illustrated in FIG. 5 as independent functional units of the user terminal 10 can be configured as a single functional unit. On the other hand, regarding a single functional unit of the user terminal 10 illustrated in FIG. 5, the corresponding function can be divided into a plurality of functions and a plurality of functional units can be configured for implementing those functions.

### Configuration and Operations of Functional Blocks of Memory Management Device

As illustrated in FIG. 5, the memory management device 20 includes a video model (database) DB 21, a personality model DB 22, a virtual person data storing unit 23, and a communication processing unit 29.

The video model DB 21 is a database used to store a plurality of types of video models configured with videos of persons performing movements. A video model implies a video template used for generating a video of a virtual person. Moreover, a video model represents data that particularly constitutes the shape and the movements of the trunk. Furthermore, as explained later, in a video model, face data is used in a consolidated manner. Meanwhile, the video models contain data of a plurality of types of persons having different body types according to the height, the weight, and the age. Moreover, the video models contain reproducible data of a plurality of types of clothing wearable by different persons. Moreover, the video models contain a variety of data of the movements of persons having different appearances. For example, the data of the movements frequently performed during a dialogue, such as nodding, folding the hands, and raising a hand, is included in a video model. The video model DB 21 is implemented using the auxiliary memory device 705 illustrated in FIG. 4. Meanwhile, a video model either can be a video obtained by capturing an actual person, or can be a video modeled using computer graphics (CG), or can be a video made using both those aspects.

The personality model DB 22 is used to store a plurality of types of personality models of persons. A personality model includes, for example, the attributes of the answers to questions, and is meant for deciding the line of answers such as whether the answers have positive content or negative content and for deciding the emotions expressed in the answers. Meanwhile, a personality model is not limited to the answers given by the user to the questions, and can also include the attributes of messages corresponding to the season or the time slot. In the personality model DB 22, in line with each personality model, answers to pre-assumed questions can also be stored. As a result, it becomes possible to reduce the computational load required to generate answers to formulaic questions corresponding to a personality model. Meanwhile, the personality model DB 22 can be a learning model obtained by performing AI-based learning (AI stands for Artificial Intelligence) with the use of a variety of learning data related to the personality. The personality model DB 22 is implemented using the auxiliary memory device 705 illustrated in FIG. 4.

The virtual person data storing unit 23 is a functional unit used to store the following as virtual person data: the video model selected by the virtual person generation device 30 (i.e., the to-be-used video model); the personality model selected by the virtual person generation device 30 (i.e., the to-be-used personality model); and the information about the voice of the virtual person as generated by the virtual person generation device 30. Moreover, the virtual person data that is stored in the virtual person data storing unit 23 is read at the time when the video generation device 40 generates a video of the concerned virtual person. The virtual person data storing unit 23 is implemented using the auxiliary memory device 705 illustrated in FIG. 4.

The communication processing unit 29 is a functional unit for performing data communication with the user terminal 10, the virtual person generation device 30, the video generation device 40, and the dialogue skill analysis device 50. The communication processing unit 29 is implemented using the network I/F 709, which is illustrated in FIG. 4, when the CPU 701 executes a computer program.

Meanwhile, the functional units such as the information source registering unit 13 and the authentication requesting unit 14 can be partially or entirely implemented using a hardware circuit (an integrated circuit), such as a field-programmable gate array (FPGA) or an application specific integrated circuit (ASIC), instead of using computer programs representing software.

The functional units of the memory management device 20 as illustrated in FIG. 5 are merely conceptual and are not limited to the configuration explained above. Alternatively, for example, a plurality of functional units illustrated in FIG. 5 as independent functional units of the memory management device 20 can be configured as a single functional unit. On the other hand, regarding a single functional unit of the memory management device 20 illustrated in FIG. 5, the corresponding function can be divided into a plurality of functions and a plurality of functional units can be configured for implementing those functions.

### Configuration and Operations of Functional Blocks of Virtual Person Generation Device

As illustrated in FIG. 5, the virtual person generation device 30 includes a video processing unit 31, a voice processing unit 32, a personality processing unit 33, an authenticating unit 34, and a communication processing unit 39.

The video processing unit 31 is a functional unit that, based on the information source registered by the information source registering unit 13 of the user terminal 10, generates information related to the video of the virtual person in the concerned virtual person data. The information related to the video of a virtual person more particularly implies, as explained later, a to-be-used video model in which the face data of the concerned virtual person is integrated. As illustrated in FIG. 5, the video processing unit 31 includes a video obtaining unit 311, a still image obtaining unit 312, a trimming unit 313, an image correcting unit 314, a video model selecting unit 315, and a face inserting unit 316. The video processing unit 31 is implemented when the CPU 701 illustrated in FIG. 4 executes a computer program.

The video processing unit 31 can generate the information related to the video of a single virtual person based on the information source registered by a plurality of user terminals 10. For example, in the case in which a large number of users conduct a dialogue with the same virtual person such as a well-known figure, each user registers the source information of a single virtual person via the corresponding user terminal 10. As a result, the virtual person can be generated based on a larger number of information sources, thereby enabling a greater sense of reality in the dialogue.

The video obtaining unit 311 is a functional unit that, from the information source registered by the information source registering unit 13 of the user terminal 10, obtains video data as external appearance data of the target person. Herein the external appearance data represents a variety of data containing the face, the body, the hairstyle, and the clothing of the target person.

Meanwhile, the video obtaining unit 311 can prompt the user to capture a video using the user terminal 10. As a situation in which a video can be captured using the user terminal 10, for example, it is possible to think of a case in which the target person is a close person to the user and in which the virtual person is to be displayed in a different user terminal 10, or a case in which a virtual person is generated in order to enable a dialogue even after the target person has passed away. In that case, the video obtaining unit 311 can display, in the user terminal 10, a tutorial for enabling the user to capture a video.

The still image obtaining unit 312 is a functional unit that, from the information source registered by the information source registering unit 13 of the user terminal 10, obtains still image data as the external appearance data of the target person. The still image obtaining unit 312 can convert either the video data of the target person as included in the information source or the video data obtained by the video obtaining unit 311 into still image data, and obtain the still image data. In that case, the still image obtaining unit 312 converts the still image data from the video data in such a way that images of the target person from various angles and images of various expressions of the target person are included.

The still image obtaining unit 312 can prompt the user to capture a still image using the user terminal 10. In that case, the still image obtaining unit 312 can display, in the user terminal 10, a tutorial for enabling the user to capture a still image, that is, a photograph.

The trimming unit 313 is a functional unit that, from the still image data obtained by the still image obtaining unit 312, trims and extracts the data of the target person. For example, the trimming unit 313 is equipped with the face recognition function by which the face of the target person is recognized from the still image data obtained by the still image obtaining unit 312, and the data of the face region is extracted as the face data.

The image correcting unit 314 is a functional unit that performs color tone correction and resolution correction with respect to the face data extracted by the trimming unit 313, and achieves a homogenous quality of the extracted face data. Moreover, the image correcting unit 314 can determine whether or not the face data extracted by the trimming unit 313 is vivid and, if blurred face data is extracted, can exclude that face data. Furthermore, if the face data has the resolution equal to or lower than a predetermined level, then the image correcting unit 314 can exclude that face data.

The video model selecting unit 315 is a functional unit that, from among the video models stored in the video model DB 21 of the memory management device 20, selects the video model to be used in generating a video of the concerned virtual person. The video model selected by the video model selecting unit 315 is sometimes called the to-be-used video model. The video model selecting unit 315 can select the most resembling video model to the target person based on, for example, either the video data obtained as the external appearance by the video obtaining unit 311 or the still image data obtained as the external appearance data by the still image obtaining unit 312. Moreover, for example, the video model selecting unit 315 can present to the user terminal 10 a plurality of video models stored in the video model DB 21, and can select the video model selected by the user. As a result, even when a sufficient number of information sources indicating the target person are not registered by the information source registering unit 13, it still becomes possible to select a video model to be used in generating a video of the virtual person. Moreover, for example, the video model selecting unit 315 can select a video model based on the clothing or the belongings of the target person as indicated by the external appearance data obtained by the video obtaining unit 311 or the still image obtaining unit 312. That is, if the information source indicating the clothing of the target person is available, then it becomes possible to select a video model meant for generating a video of the virtual person based on that information source. Thus, even when the information source of the target person is not sufficiently available, a video model can be selected based on the clothing or the belongings of the target person, and a video of the virtual person can be generated.

Moreover, since clothing data can also be selected from the video model DB 21, even when the information source related to the clothing of the target person is not sufficiently available, the virtual person can be generated with ease. Furthermore, the video model selecting unit 315 can configure video models of the virtual person wearing a plurality of types of clothing, so that the clothing can be made variable based on the season, the time slot, or the user selection. Moreover, regarding the hairstyle of the virtual person to be generated, the video model selecting unit 315 either can decide on the hairstyle based on the external appearance data or can select the hairstyle from the video model DB 21. Moreover, the video model selecting unit 315 can configure video models of the virtual person having a plurality of types of hairstyle, so that the hairstyle can be made variable.

In the explanation given till now, it is assumed that the video processing unit 31 extracts the data of the virtual person based on the information source of the target person. However, alternatively, a video or a still image of a person resembling the target person can be newly captured, and can be used in the selection of the video model for the virtual person. Still alternatively, the external appearance data of a resembling person, such as the hairstyle or the clothing, can be partially used in the selection of the video model for the virtual person. That is, of the external appearance data, the elements to be used in generating a video model of the virtual person can be made user-selectable.

The face inserting unit 316 is a functional unit that integrates the face data, which has been corrected by the image correcting unit 314, into the to-be-used video model selected by the video model selecting unit 315. That is, the face inserting unit 316 integrates the face data to the trunk of the virtual person configured according to the to-be-used video model, and as a result a full-length figure of the virtual person is configured. Then, the face inserting unit 316 stores the used video data, to which the face data has been integrated, in the virtual person data storing unit 23 of the memory management device 20.

The voice processing unit 32 is a functional unit that, based on the information source registered in the information source registering unit 13 of the user terminal 10, artificially generates a voice for the virtual person. As illustrated in FIG. 5, the voice processing unit 32 includes a voice extracting unit 321 and a voice generating unit 322. The voice processing unit 32 is implemented when the CPU 701 illustrated in FIG. 4 executes a computer program.

The voice extracting unit 321 is a functional unit that extracts the voice of the target person from the information source registered by the information source registering unit 13 of the user terminal 10. For example, from among a plurality of types of voices included in the information source, the voice extracting unit 321 can treat, as the voice of the target person, that voice of a person which is included for the longest period of time.

The voice generating unit 322 is a functional unit that generates the voice of the virtual person based on the voice of the target person as extracted by the voice extracting unit 321. Then, the voice generating unit 322 can trim the voice extracted by the voice extracting unit 321, and edit it to be reproducible as the voice of the virtual person. Alternatively, for example, from among the voice data provided in advance, the voice generating unit 322 can select the voice resembling the extracted voice of the target person, and can treat the selected voice as the voice of the virtual person. Still alternatively, the voice generating unit 322 can generate an artificial voice resembling the extracted voice of the target person. Meanwhile, if the messages from the virtual person are to be displayed in the text form, then the voice need not be generated. Subsequently, the voice generating unit 322 stores the information about the generated voice of the virtual person in the virtual person data storing unit 23 of the memory management device 20.

The personality processing unit 33 is a functional unit that decides on and corrects the personality model of the virtual person. As illustrated in FIG. 5, the personality processing unit 33 includes a text data registering unit 331, a personality model selecting unit 332, and a personality model correcting unit 333. The personality processing unit 33 is implemented when the CPU 701 illustrated in FIG. 4 executes a computer program.

The text data registering unit 331 is a functional unit that extracts text data from the information source and registers the text data in the virtual person data storing unit 23. For example, from among the information source, the text data registering unit 331 extracts the text data from the blogs or the SNS used by the target person, and registers the text data in the virtual person data storing unit 23 according to predetermined rules. Alternatively, for example, the text data registering unit 331 can convert, from among the information source, the handwritten records (for example, a diary) of the target person into text data and register it in the virtual person data storing unit 23. Still alternatively, for example, the text data registering unit 331 can convert, from among the information source, the voice of the target person, which is included in the voice data or the video data, into text data and register it in the virtual person data storing unit 23.

The personality model selecting unit 332 is a functional unit that, from among the personality models stored in the personality model DB 22 of the memory management device 20, selects the personality model to be used in generating the video of the virtual person. The personality model selected by the personality model selecting unit 332 is sometimes referred to as the to-be-used personality model. For example, firstly, the personality model selecting unit 332 presents, via the user terminal 10, a question related to the personality of the target person. When the answer to that question is input from the user terminal 10, the personality model selecting unit 332 selects, based on the answer, the personality model to be used in generating the video of the virtual person from among the personality models stored in the personality model DB 22. Meanwhile, a plurality of questions can also be asked about the personality. Moreover, the questions can be asked according to a chart in which each input answer and the next question to be asked are held in a corresponding manner. Subsequently, the personality model selecting unit 332 stores the to-be-used personality model, which has been selected, in the virtual person data storing unit 23 of the memory management device 20.

In this way, as the user goes on answering the questions, based on the basic types of personalities provided in advance, the basic personality of the virtual person is defined. If the personality is to be defined according to the information about the actual dialogues of the target person, then it becomes necessary to have an enormous volume of information about the dialogues. However, in the dialogue training system 1 according to the present embodiment, based on the answers given to the questions related to the personality, it becomes possible to classify the personality into one of the types provided in advance. Hence, even when the information related to the target person is not sufficiently available, the personality of the virtual person can be defined using a simple configuration. Meanwhile, the personality model for the virtual person can be set for each scenario pattern corresponding to the type of question from the user. A scenario pattern implies, for example, everyday conversation or discussion about one's problems. When personality models are decided for some of the scenario patterns, the configuration can allow a dialogue in line with those scenario patterns. With such a configuration, as soon as the personality models regarding necessary scenario patterns are decided, a dialogue can be conducted. Hence, the configuration becomes easy to use.

Meanwhile, the voice generating unit 322 can determine the characteristics indicating the personality from the text data extracted by the text data registering unit 331, and can select the personality model matching with the determination result.

The personality model correcting unit 333 is a functional unit that corrects the user personality model selected by the personality model selecting unit 332. For example, the personality model correcting unit 333 receives the user evaluation of the answers given by the virtual person during a dialogue training, and corrects the to-be-used personality model based on that evaluation. For example, the user evaluates whether or not the answers from the virtual person were matching with the personality of the target person if the target person had given the answers, and inputs the evaluation. Moreover, the user can also input the evaluation about the movements of the virtual person that accompanied the answers. Then, for example, the personality model correcting unit 333 can perform AI-based learning by using the user evaluation as the learning data and correct the to-be-used personality model. As a result, the personality of the virtual person can be corrected to be closer to the personality of the target person.

Meanwhile, in the case in which a plurality of user terminals 10 conducts a dialogue with the same virtual person either at the same time or at different timings, the personality model correcting unit 333 can correct the to-be-used personality model of that virtual person based on the evaluation received from a plurality of user terminals 10. As a result, a large number of feedbacks can be given to the to-be-used personality model of the virtual person, thereby making it possible to bring the to-be-used personality model of the virtual person closer to the personality of the target person and to enhance the dialogue accuracy.

Meanwhile, instead of performing correction based on the user evaluation, the personality model correcting unit 333 can refer to the answers given by the user to the messages coming from the virtual person during the dialogue training and determine whether or not the messages were appropriate, and can accordingly correct the to-be-used personality model. In that case, the personality model correcting unit 333 can convert the user answers into text data, analyze the text data, and analogize the degree of satisfaction from the tone of voice of the user.

The authenticating unit 34 is a functional unit that, in response to a request for login authentication received from the user terminal 10, performs an authentication operation regarding the user of the user terminal 10. The authenticating unit 34 is implemented when the CPU 701 illustrated in FIG. 4 executes a computer program.

The communication processing unit 39 is a functional unit that performs data communication with the user terminal 10, the memory management device 20, the video generation device 40, and the dialogue skill analysis device 50 via the network N. The communication processing unit 39 is implemented using the network I/F 709, which is illustrated in FIG. 4, when the CPU 701 executes a computer program.

Meanwhile, the functional units such as the video processing unit 31, the voice processing unit 32, the personality processing unit 33, and the authenticating unit 34 can be partially or entirely implemented using a hardware circuit (an integrated circuit), such as an FPGA or an ASIC, instead of using computer programs representing software.

Moreover, the functional units of the virtual person generation device 30 as illustrated in FIG. 5 are merely conceptual and are not limited to the configuration explained above. Alternatively, for example, a plurality of functional units illustrated in FIG. 5 as independent functional units of the virtual person generation device 30 can be configured as a single functional unit. On the other hand, regarding a single functional unit of the virtual person generation device 30 illustrated in FIG. 5, the corresponding function can be divided into a plurality of functions and a plurality of functional units can be configured for implementing those functions.

### Configuration and Operations of Functional Blocks of Video Generation Device

As illustrated in FIG. 5, the video generation device 40 includes a video display processing unit 41, a dialogue processing unit 42, and a communication processing unit 49.

The video display processing unit 41 is a functional unit that refers to the virtual person data storing unit 23 of the memory management device 20 and, using the to-be-used video model in which the face data has been integrated by the video processing unit 31, generates an utterance video including utterances made by the virtual person. The video display processing unit 41 performs modeling of the face data that is integrated with the to-be-used video model, and generates an utterance video that is run in tune with the utterances. Then, the video display processing unit 41 sends the generated utterance video to the user terminal 10 via the communication processing unit 49, so that the utterance video is reproduced in the user terminal 10. The video display processing unit 41 is implemented when the CPU 701 illustrated in FIG. 4 executes a computer program.

The dialogue processing unit 42 is a functional unit that refers to the virtual person data storing unit 23 of the memory management device 20 and, based on the to-be-used personality model selected by the personality processing unit 33, generates a message to be uttered by the virtual person. If the to-be-used personality model is a learning model obtained as a result of AI-based learning, then the dialogue processing unit 42 decides on the most suitable answer according to the to-be-used personality model representing a learning model. Subsequently, the dialogue processing unit 42 refers to the virtual person data storing unit 23 of the memory management device 20 and, using the information about the voice of the virtual person, generates voice data in which the generated message is uttered. The dialogue processing unit 42 sends the generated voice data to the user terminal 10 via the communication processing unit 49, so that the voice data is reproduced in the user terminal 10.

The communication processing unit 49 is a functional unit that performs data communication with the user terminal 10, the memory management device 20, the virtual person generation device 30, and the dialogue skill analysis device 50 via the network N. The communication processing unit 49 is implemented using the network I/F 709, which is illustrated in FIG. 4, when the CPU 701 executes a computer program.

Meanwhile, the functional units such as the video display processing unit 41, the dialogue processing unit 42, and the communication processing unit 49 can be partially or entirely implemented using a hardware circuit (an integrated circuit), such as an FPGA or an ASIC, instead of using computer programs representing software.

Moreover, the functional units of the video generation device 40 as illustrated in FIG. 5 are merely conceptual and are not limited to the configuration explained above. Alternatively, for example, a plurality of functional units illustrated in FIG. 5 as independent functional units of the video generation device 40 can be configured as a single functional unit. On the other hand, regarding a single functional unit of the video generation device 40 illustrated in FIG. 5, the corresponding function can be divided into a plurality of functions and a plurality of functional units can be configured for implementing those functions.

### Configuration and Operations of Functional Blocks of Dialogue Skill Analysis Device

As illustrated in FIG. 5, the dialogue skill analysis device 50 includes a dialogue data obtaining unit 51 (an obtaining unit), a dialogue data analyzing unit 52, a dialogue skill determining unit 53, an emotion data analyzing unit 54 (a second analyzing unit), an analysis result output unit 55 (an output unit), and a communication processing unit 59.

The dialogue data obtaining unit 51 is a functional unit that, during the dialogue training of the user being conducted using the user terminal 10, obtains, via the communication processing unit 59, the video data and the voice data of the user as input from the input unit 11 of the user terminal 10. The dialogue data obtaining unit 51 is implemented when the CPU 701 illustrated in FIG. 4 executes a computer program. Meanwhile, from the video data obtained by the dialogue data obtaining unit 51 during the dialogue with a virtual person, the face information of the user can be obtained and biological data such as the blood pressure, the pulsation, and the cholesterol value can be obtained from the face information. With that, it becomes possible to find out the stress, the fatigue, and early signs of various symptoms. In that case, for example, the face information can be obtained by inference from the changes in the facial skin occurring due to the blood flow. Moreover, in addition to the face information; data such as the voice volume, the voice pitch, and the utterance speed of the voice data obtained by the dialogue data obtaining unit 51 can be used to perform multimodal analysis, so that the measurement accuracy can be enhanced. Moreover, if the video data is obtained while correcting the posture of the user during the dialogue, then it becomes possible to obtain accurate face information without causing any misalignment in the position of the face. Moreover, if an attempt is made to read biological data such as the blood pressure, the pulsation, and the cholesterol value from a face image, although a period of time is required for the reading, the advantage in the dialogue training system 1 of the interactive type is that the data processing can be performed during the dialogue itself.

The dialogue data analyzing unit 52 is a functional unit that, based on the video data and the voice data obtained by the dialogue data obtaining unit 51, analyzes the feature quantities regarding the following types of dialogue skills during the dialogue with another person (the virtual person): the attentive listening skill indicating the skill of attentively listening to the answer/response of the other person; the acknowledgment skill indicating the skill of accepting and acknowledging the answer/response of the other person; and the questioning skill indicating the skill of asking open questions and the skill of questioning. As illustrated in FIG. 5, the dialogue data analyzing unit 52 includes an image analyzing unit 521 and a voice analyzing unit 522. The dialogue data analyzing unit 52 is implemented when the CPU 701 illustrated in FIG. 4 executes a computer program.

As illustrated in FIGS. 7 and 8, the image analyzing unit 521 calculates, from the video data obtained by the dialogue data obtaining unit 51, the number of times nodding to the other person (the virtual person) is performed as a feature quantity of the attentive listening skill and the acknowledgment skill. Moreover, as illustrated in FIGS. 7 and 8, the image analyzing unit 521 calculates, from the video data obtained by the dialogue data obtaining unit 51, the number of times smiling at the other person is performed as a feature quantity of the attentive listening skill. Meanwhile, the feature quantities of the attentive listening skill and the acknowledgment skill are not limited to the number of times nodding is performed and the number of times smiling is performed (representing examples of the behavior). Alternatively, at least either the number of times nodding is performed or the number of times smiling is performed can be used, or some other feature quantities can be used.

The image analyzing unit 521 detects, for example, items “expressions” and “behavior” of the user from the video data. The item “expressions” is used to record the result of counting, at regular intervals, the expression parameters to which correspond the expressions of the user calculated based on the feature quantities, which are extracted from the face region of the user included in the video data. The expression parameters specified in the item “expressions” include “anger”, “contempt”, “dislike”, “impatience”, “joy”, “sadness”, “amazement”, and “indifference”. The item “behavior” is used to record the calculation result obtained by calculating the amount of movement of each body part of the user included in the video data. The behavior parameters specified in the item “behavior” include “head movement”, “body movement”, “lip movement”, and “eye movement”. For example, the parameter “head movement” is used to record the average value of the amounts of movement at regular intervals as derived by detecting the position of the head region of the user with the use of the video data and calculating the amount of movement of the position of the head region. The image analyzing unit 521 analyzes the postures and the gestures of the user based on the behavior.

As illustrated in FIGS. 7 and 8, the voice analyzing unit 522 calculates, from the voice data obtained by the dialogue data obtaining unit 51, the number of times positive reception is made to the other person (the virtual person) as a feature quantity of the acknowledgment skill. In that case, regarding whether or not positive reception was seen, for example, it can be determined whether or not the words included in the voice data match with supposedly positive words registered in dictionary data, or threshold value determination can be performed with respect to a numerical value representing the sound pitch or the tone in the voice data. Moreover, as illustrated in FIGS. 7 and 8, the voice analyzing unit 522 calculates, from the voice data obtained by the dialogue data obtaining unit 51, the number of times concern for the other person is made as a feature quantity of the acknowledgment skill. Furthermore, as illustrated in FIGS. 7 and 8, the voice analyzing unit 522 calculates, from the voice data obtained by the dialogue data obtaining unit 51, the number of times a voice is uttered as a supportive response to the other person as a feature quantity of the attentive listening skill. Moreover, as illustrated in FIGS. 7 and 8, the voice analyzing unit 522 calculates, from the voice data obtained by the dialogue data obtaining unit 51, the number of times an open question to the other person is made as a feature quantity of the questioning skill. Furthermore, as illustrated in FIGS. 7 and 8, the voice analyzing unit 522 calculates, from the voice data obtained by the dialogue data obtaining unit 51, the utterance ratio during the dialogue with the other person as a feature quantity of the attentive listening skill. Meanwhile, the feature quantities of the attentive listening skill, the acknowledgment skill, and the questioning skill are not limited to the number of times a positive reception is made, the number of times a concern is made, the number of times a supportive response is made, the number of times an open question is made, and the utterance ratio during a dialogue (examples of an answer). Alternatively, at least either the number of times a positive reception is made, or the number of times a concern is made, or the number of times a supportive response is made, or the number of times an open question is made, or the utterance ratio during a dialogue can be treated as the feature quantity. Still alternatively, some other feature quantities can also be used.

The voice analyzing unit 522 detects, for example, items “tone”, “utterance count”, “utterance period”, “spell-of-silence count”, “silent period”, and “utterance details” of the user from the voice data. The item “tone” is used to record the feature quantity that is obtained when the voice data is subjected to language analysis and when the pitch pattern of the voice used in differentiating the meaning in a language is calculated. The items “utterance count” and “utterance period” are used to record the number of times the user has made an utterance during the dialogue training and the period of time for which the user has made the utterance. The items “spell-of-silence count” and “silent period” are used to record the number of times the user has remained silent during the dialogue training and the period of time for which the user has remained silent. The item “utterance details” is used to record the text form of the details of the utterances made by the user during the dialogue training.

Meanwhile, the operation of calculating the feature quantities of the attentive listening skill, the acknowledgment skill, and the questioning skill as performed by the dialogue data analyzing unit 52 can be performed using an AI-based learning model such as machine learning.

The contrasting skill determining unit 53 is a functional unit that, as illustrated in FIGS. 7 and 8, quantifies the attentive listening skill, the acknowledgment skill, and the questioning skill based on the feature quantities of the attentive listening skill, the acknowledgment skill, and the questioning skill as calculated by the dialogue data analyzing unit 52. The contrasting skill determining unit 53 is implemented when the CPU 701 illustrated in FIG. 4 executes a computer program.

Herein, the attentive listening skill, the acknowledgment skill, and the questioning skill are explained as the dialogue skills analyzed by the dialogue data analyzing unit 52 and the contrasting skill determining unit 53. However, that is not the only possible case. Alternatively, at least one of the attentive listening skill, the acknowledgment skill, and the questioning skill can be treated as the target dialogue skill for analysis; or some other dialogue skills can be treated as the target dialogue skills for analysis. Meanwhile, at least either the dialogue data analyzing unit 52 or the contrasting skill determining unit 53 corresponds to a “first analyzing unit”.

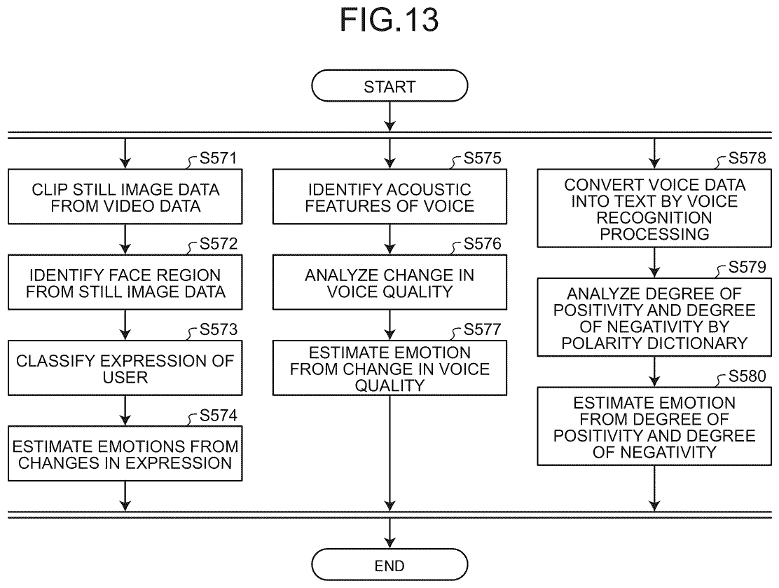

The emotion data analyzing unit 54 is a functional unit that, based on the video data and the voice data obtained by the dialogue data obtaining unit 51, analyzes the emotions of the user during the dialogue training. Firstly, for example, as illustrated in FIG. 6, the emotion data analyzing unit 54 obtains emotion data such as “indifference”, “anger”, “impatience”, “joy”, and “contempt” from the expressions of the user in the video data or from the voice data. Then, the emotion data analyzing unit 54 sends the obtained emotion data to the video generation device 40 via the communication processing unit 59. The emotion data that is obtained as a result of analysis performed by the emotion data analyzing unit 54 has an impact on the reaction of the virtual person. For example, as illustrated in FIG. 6, when the emotion data of the user indicates “indifference”, the virtual person reacts with “indifference”. When the emotion data indicates “anger”, the virtual person reacts with “cowering”. When the emotion data indicates “impatience”, the virtual person reacts with “ridicule”. When the emotion data indicates “joy”, the virtual person reacts with “joy”. When the emotion data indicates “contempt”, the virtual person reacts with “anger”. In tune with each reaction of the virtual person, the video generation device 40 generates an utterance video of the virtual person, generates a message to be uttered, and generates voice data in which that message is uttered. The emotion data analyzing unit 54 is implemented when the CPU 701 illustrated in FIG. 4 executes a computer program. Regarding the operation of analyzing the emotion data as performed by the emotion data analyzing unit 54, the detailed explanation is given later with reference to FIG. 13.

The analysis result output unit 55 is a functional unit that generates information indicating the analysis result about the attentive listening skill, the acknowledgment skill, and the questioning skill which have been quantified by the contrasting skill determining unit 53. For example, as illustrated in FIG. 7, the analysis result output unit 55 generates, as the information indicating the analysis result, an output image 1001 of a radar chart indicating the quantified values of the attentive listening skill, the acknowledgment skill, and the questioning skill. Meanwhile, the display element for indicating the quantified values of the attentive listening skill, the acknowledgment skill, and the questioning skill is not limited to a radar chart. Alternatively, for example, the analysis result output unit 55 converts the voice data, which is obtained by the dialogue data obtaining unit 51, into the text form; and, using the attentive listening skill, the acknowledgment skill, and the questioning skill in the quantified form, generates an output image 1002, in which the portions of the text having contribution from the attentive listening skill, the acknowledgment skill, and the questioning skill are highlighted with a marker/shading or are displayed in a different form than the surrounding portion, as the information indicating the analysis result. Then, the analysis result output unit 55 sends the generated information indicating the analysis result to the user terminal 10 via the communication processing unit 59, so that the information is displayed in the user terminal 10. The analysis result output unit 55 is implemented when the CPU 701 illustrated in FIG. 4 executes a computer program.

The communication processing unit 59 is a functional unit that performs data communication with the user terminal 10, the memory management device 20, the virtual person generation device 30, and the video generation device 40 via the network N. The communication processing unit 59 is implemented using the network I/F 709, which is illustrated in FIG. 4, when the CPU 701 executes a computer program.

Meanwhile, the functional units such as the dialogue data obtaining unit 51, the dialogue data analyzing unit 52, the contrasting skill determining unit 53, the emotion data analyzing unit 54, and the analysis result output unit 55 can be partially or entirely implemented using a hardware circuit (an integrated circuit), such as an FPGA or an ASIC, instead of using computer programs representing software.

Moreover, the functional units of the dialogue skill analysis device 50 as illustrated in FIG. 5 are merely conceptual and are not limited to the configuration explained above. Alternatively, for example, a plurality of functional units illustrated in FIG. 5 as independent functional units of the dialogue skill analysis device 50 can be configured as a single functional unit. On the other hand, regarding a single functional unit of the dialogue skill analysis device 50 illustrated in FIG. 5, the corresponding function can be divided into a plurality of functions and a plurality of functional units can be configured for implementing those functions.

### Flow of Operations Performed for Deciding on Video Model of Virtual Person in Dialogue Training System

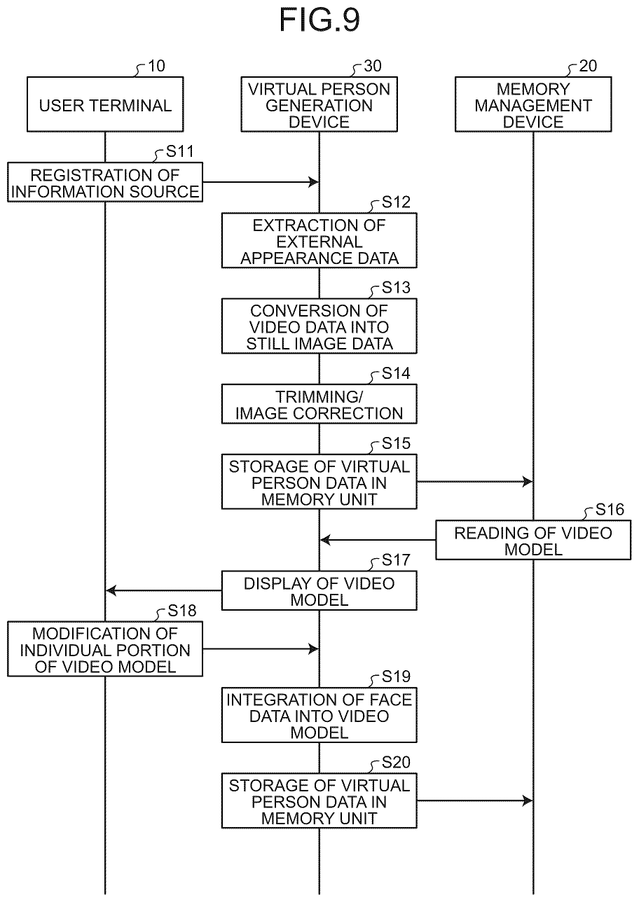

FIG. 9 is a sequence diagram illustrating an exemplary flow of operations performed for deciding on the video model of the virtual person in the dialogue training system according to the embodiment. Thus, explained below with reference to FIG. 9 is the flow of operations performed for deciding on the video model of the virtual person in the dialogue training system according to the embodiment.

### Step S11

In the user terminal 10, the information source registering unit 13 obtains the information source related to the target person (for example, a subordinate) who serves as the model for the virtual person, and registers the source information in the auxiliary memory device 604. Moreover, the information source registering unit 13 sends the registered information source to the virtual person generation device 30 at an appropriate timing via the communication processing unit 19.

### Step S12

In the virtual person generation device 30, the video obtaining unit 311 of the video processing unit 31 obtains, from the information source registered by the information source registering unit 13 of the user terminal 10, video data as the external appearance data of the target person.

### Step S13

In the virtual person generation device 30, the still image obtaining unit 312 of the video processing unit 31 obtains still image data as the external appearance data of the target person. Moreover, the still image obtaining unit 312 converts either the video data of the target person as included in the information source or the video data obtained by the video obtaining unit 311 into still image data.

### Step S14

In the virtual person generation device 30, the trimming unit 313 of the video processing unit 31 trims and extracts the face data of the target person from the still image data obtained by the still image obtaining unit 312. Moreover, in the virtual person generation device 30, the image correcting unit 314 of the video processing unit 31 performs color tone correction and resolution correction of the face data extracted by the trimming unit 313, and achieves a homogenous quality of the extracted face data.

### Step S15

In the virtual person generation device 30, the image correcting unit 314 of the video processing unit 31 stores the corrected video data in the virtual person data storing unit 23 of the memory management device 20.

### Step S16

In the virtual person generation device 30, the video model selecting unit 315 of the video processing unit 31 selects and reads a video model to be used in generating a video of the concerned virtual person (i.e., a to-be-used video model) from among the video models stored in the video model DB 21 of the memory management device 20. For example, based on the video data representing the external appearance data obtained by the video obtaining unit 311 or based on the still image data representing the external appearance data obtained by the still image obtaining unit 312, the video model selecting unit 315 selects the most resembling video model to the target person.

Step S17 The video model selecting unit 315 sends the selected and read video model to the user terminal 10 via the communication processing unit 39, so that the video model is displayed in the user terminal 10. At that time, a plurality of candidates of the video model can be displayed in the user terminal 10, and the to-be-used video model can be made selectable in the user terminal 10. Alternatively, a video model different than the presented video model can be made selectable as the to-be-used video model in the user terminal 10.

### Step S18

Then, the user terminal 10 receives input for changing individual portions of the used video model. The individual portions include the outline, the eyes, the nose, the mouth, the hairstyle, and the clothing regarding which the selection can be input.

### Step S19

In the virtual person generation device 30, the face inserting unit 316 of the video processing unit 31 integrates the face data, which has been corrected by the image correcting unit 314, to the to-be-used video model in which the portions have been modified at Step S18.

### Step S20

The face inserting unit 316 stores the to-be-used video model, to which the face data has been integrated, to the virtual person data storing unit 23 of the memory management device 20.

### Flow of Operations Performed for Generating Voice of Virtual Person in Dialogue Training System

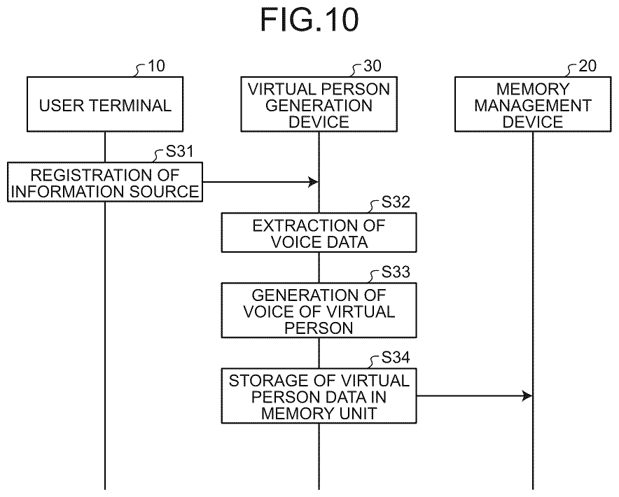

FIG. 10 is a sequence diagram illustrating an exemplary flow of operations performed for generating the voice of the virtual person in the dialogue training system according to the embodiment. Thus, explained below with reference to FIG. 10 is the flow of operations performed for generating the voice of the virtual person in the dialogue training system according to the embodiment.

### Step S31

In the user terminal 10, the information source registering unit 13 obtains the information source related to the target person (for example, a subordinate) who serves as the model for the virtual person, and registers the information source in the auxiliary memory device 604. Moreover, the information source registering unit 13 sends the registered information source to the virtual person generation device 30 at an appropriate timing via the communication processing unit 19.

### Step S32

In the virtual person generation device 30, the voice extracting unit 321 of the voice processing unit 32 extracts the voice of the target person from the information source registered by the information source registering unit 13 of the user terminal 10. For example, from among a plurality of types of voices included in the information source, the voice extracting unit 321 can treat the voice of the person that is included for the longest period of time as the voice of the target person.

### Step S33

In the virtual person generation device 30, the voice generating unit 322 of the voice processing unit 32 generates the voice of the virtual person based on the voice of the target person as extracted by the voice extracting unit 321.

### Step S34

The voice generating unit 322 stores the generated information about the voice of the virtual person in the virtual person data storing unit 23 of the memory management device 20.

### Flow of Operations Performed for Deciding on Personality Model of Virtual Person in Dialogue Training System

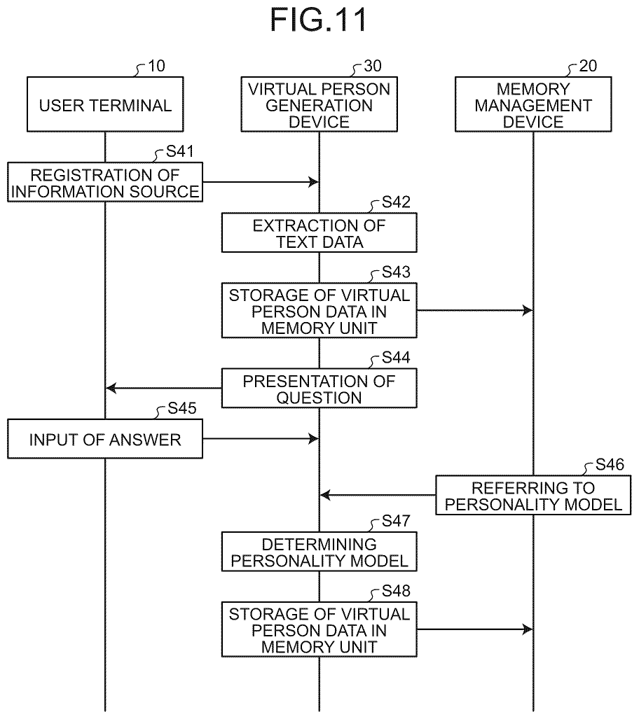

FIG. 11 is a sequence diagram illustrating an exemplary flow of operations performed for deciding on the personality model of the virtual person in the dialogue training system according to the embodiment. Thus, explained below with reference to FIG. 11 is the flow of operations performed for deciding on the personality model of the virtual person in the dialogue training system according to the embodiment.

### Step S41

In the user terminal 10, the information source registering unit 13 obtains the information source related to the target person (for example, a subordinate) who serves as the model for the virtual person, and registers the source information in the auxiliary memory device 604. Moreover, the information source registering unit 13 sends the registered information source to the virtual person generation device 30 at an appropriate timing via the communication processing unit 19.

### Step S42

In the virtual person generation device 30, the text data registering unit 331 of the personality processing unit 33 extracts the text data from the information source.

### Step S43

The text data registering unit 331 registers the extracted text data in the virtual person data storing unit 23.

### Step S44

In the virtual person generation device 30, the personality model selecting unit 332 of the personality processing unit 33 presents, via the user terminal 10, a question related to the personality of the target person.

### Step S45

The user inputs an answer to the question via the user terminal 10, and the personality model selecting unit 332 receives that answer from the user terminal 10.

### Step S46

The personality model selecting unit 332 refers to the personality models stored in the personality model DB 22 of the memory management device 20.

### Step S47

Based on the answer received from the user terminal 10, the personality model selecting unit 332 selects (decides on) the to-be-used personality model from among the personality models stored in the personality model DB 22.

### Step S48

The personality model selecting unit 332 stores the to-be-used personality model, which has been selected, in the virtual person data storing unit 23 of the memory management device 20.

Operations Performed for Taking Dialogue Training by Conducting Dialogue with Virtual Person in Dialogue Training System

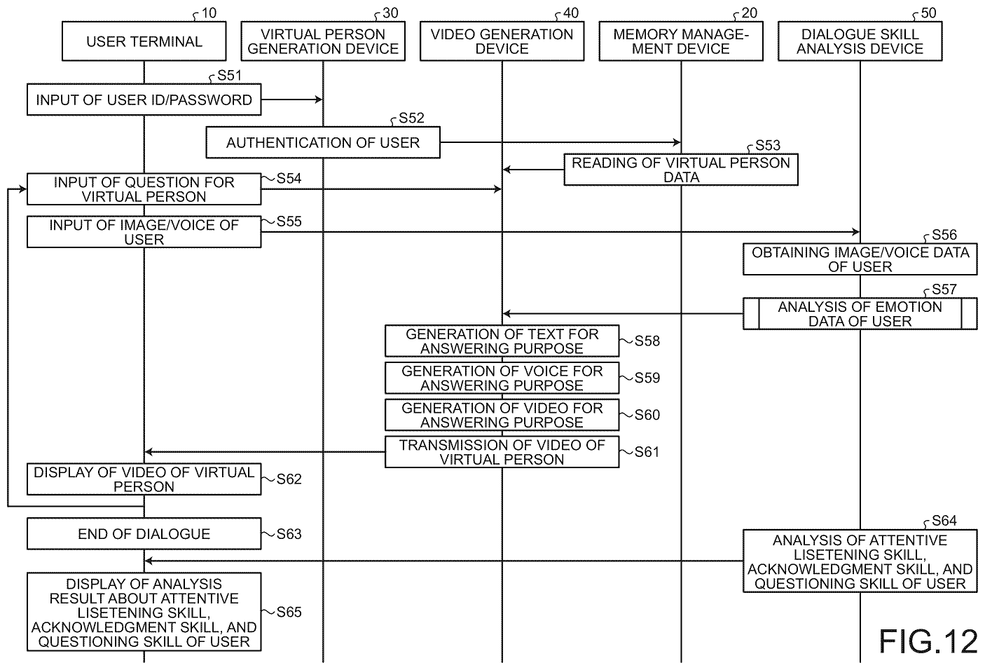

FIG. 12 is a sequence diagram illustrating an exemplary flow of operations performed for taking the dialogue training by conducting a dialogue with the virtual person in the dialogue training system according to the embodiment. FIG. 13 is a flowchart for explaining an exemplary flow of an analysis operation performed for analyzing the emotion data in the dialogue skill analysis device according to the embodiment. Thus, explained below with reference to FIGS. 12 and 13 is the flow of operations performed for taking the dialogue training by conducting a dialogue with the virtual person in the dialogue training system according to the embodiment.

### Step S51

The user attempting to take the dialogue training operates the input unit 11 of the user terminal 10 and inputs the user ID and the password with the aim of using the dialogue training system 1. In the user terminal 10, when the user uses the dialogue training system 1, the authentication requesting unit 14 issues a request to the virtual person generation device 30 for login authentication based on the input user ID and the input password.

### Step S52

In the virtual person generation device 30, in response to the login authentication request received from the user terminal 10, the authenticating unit 34 performs authentication of the user with the use of the user ID and the password input in the user terminal 10. In that case, the authenticating unit 34 performs authentication by collating the user information, which is stored in the memory management device 20, with the user ID and the password. At that time, it is possible to stage an incoming call for chatting from the virtual person, or to stage an incoming phone call from the virtual person, or to stage an incoming email from the virtual person.

### Step S53

After the user authentication is successful in the virtual person generation device 30, the video generation device 40 refers to the virtual person data storing unit 23 of the memory management device 20 and reads the virtual person data. The virtual person data contains: the to-be-used video model having the face data integrated thereto; the to-be-used personality model; and the information about the voice of the virtual person. At that point of time, based on the virtual person data, the video generation device 40 can generate a video of the virtual person and display it in the user terminal 10.

### Step S54

The user operates the input unit 11 of the user terminal 10 and inputs a question for the virtual person. The communication processing unit 19 of the user terminal 10 sends the voice data of the question, which is input in the input unit 11, to the video generation device 40.

### Step S55

The input unit 11 of the user terminal 10 receives input of the voice data of the question asked by the user to the virtual person, and receives input of an image of the user. The communication processing unit 19 sends, to the dialogue skill analysis device 50, the video data that is based on the voice data and the image input to the input unit 11.

### Step S56

In the dialogue skill analysis device 50, the dialogue data obtaining unit 51 obtains the video data and the voice data of the user, which is input to the input unit 11 of the user terminal 10, via the communication processing unit 59.

### Step S57

In the dialogue skill analysis device 50, the emotion data analyzing unit 54 analyzes the emotions of the user during the dialogue training based on the video data and the voice data obtained by the dialogue data obtaining unit 51. More particularly, the emotion data analyzing unit 54 analyzes the emotions of the user during the dialogue training according to the flow illustrated in FIG. 13. The emotion data analyzing unit 54 performs different sets of operations in parallel starting from Step S571, Step S575, and Step S578, respectively, as illustrated in FIG. 13.

### Step S571

The emotion data analyzing unit 54 clips, from the video data obtained by the dialogue data obtaining unit 51, the still image data that contains the face of the user. Then, the system control proceeds to Step S572.

### Step S572

The emotion data analyzing unit 54 identifies the face region of the user from the clipped still image data. Then, the system control proceeds to Step S573.

### Step S573

The emotion data analyzing unit 54 analyzes the facial expressions of the user from the identified face region, and classifies the expressions into a plurality of types. For example, the emotion data analyzing unit 54 follows a learning model subjected to machine learning in advance and, from the identified face region, classifies the facial expressions of the user into a plurality of types. Then, the system control proceeds to Step S574.

### Step S574

Based on the analysis result, the emotion data analyzing unit 54 analyzes whether there are positive changes in the expressions or negative changes in the expressions among the successive frame images of the video data, and analyzes the extent of the changes in the expressions; and then estimates the emotions of the user from the changes in the emotions.

### Step S575

The emotion data analyzing unit 54 implements a known method of voice analysis with respect to the estimated voice data during a predetermined period of time from among the voice data obtained by the dialogue data obtaining unit 51, and identifies the acoustic features of the voice. Then, the system control proceeds to Step S576.

### Step S576

Based on the identified acoustic features, the emotion data analyzing unit 54 analyzes the manner of changes in the voice quality and the extent of changes in the voice quality. Then, the system control proceeds to Step S577.

### Step S577

The emotion data analyzing unit 54 estimates the emotions of the user from the analyzed changes in the voice quality.

### Step S578

The emotion data analyzing unit 54 converts the voice data, which is obtained by the dialogue data obtaining unit 51, into a text (character strings) by a known voice recognition processing. Then, the emotion data analyzing unit 54 performs morphological analysis of the text obtained by conversion, and eliminates the words such as particles and articles that are deemed unnecessary in describing the conversation. Then, the system control proceeds to Step S579.

### Step S579

The emotion data analyzing unit 54 analyzes the degree of positivity and the degree of negativity using an emotion polarity dictionary with respect to the post-elimination text. Then, the system control proceeds to Step S580.

### Step S580

The emotion data analyzing unit 54 estimates the emotions of the user from the degree of positivity and the degree of negativity obtained by analysis.

Based on the estimation result about the emotions as obtained at Steps S574, S577, and S580, the emotion data analyzing unit 54 obtains emotion data indicating the emotions of the user such as “anger”, “contempt”, “dislike”, “impatience”, “joy”, “sadness”, “amazement”, and “indifference”. Then, the emotion data analyzing unit 54 sends the emotion data to the video generation device 40 via the communication processing unit 59.

### Step S58

In the video generation device 40, based on the to-be-used personality model from among the virtual person data read at Step S53 and based on the emotion data of the user as obtained by the emotion data analyzing unit 54, the dialogue processing unit 42 generates a text (a message) of the answer to the question that was asked by the user in the form of voice data at Step S54. In this way, the text of the answer from the virtual person is generated by also taking into account the emotion data of the user as analyzed by the emotion data analyzing unit 54. As a result, a dialogue having a greater sense of reality can be conducted with the virtual person mapped to the target person.

### Step S59

Then, the dialogue processing unit 42 uses the information about the voice of the virtual person from among the virtual person data read at Step S53, and generates voice data in which the generated text (message) is uttered.

### Step S60

In the video generation device 40, from among the virtual person data read at Step S53, the video display processing unit 41 uses the to-be-used video model having the face data integrated thereto and generates an utterance video (video) in which the virtual person makes an utterance (gives an answer) regarding the voice data generated at Step S59.

### Step S61

In the video generation device 40, the communication processing unit 49 sends, to the user terminal 10, the voice data generated by the dialogue processing unit 42 and the utterance video (video) generated by the video display processing unit 41. Meanwhile, the communication processing unit 49 can send, to the user terminal 10, the voice data, which is generated by the dialogue processing unit 42, and the utterance video (video), which is generated by the video display processing unit 41, in an integrated manner.

### Step S62

In the user terminal 10, the output unit 12 redisplays the video that includes the voice data of the virtual person as received from the video generation device 40.

The operations from Step S54 to Step S62 are performed in a repeated manner while the dialogue training of the user is underway. As a result, the user becomes able to have a natural dialogue with the virtual person mapped to the target person.

### Step S63

In the case of ending the dialogue training, the user performs an end operation by operating the input unit 11 of the user terminal 10 and ends the dialogue training.

### Step S64

In the dialogue skill analysis device 50, based on the video data and the voice data obtained by the dialogue data obtaining unit 51, the dialogue data analyzing unit 52 analyzes the feature quantities related to the following skills: the attentive listening skill indicating the skill of attentively listening to the answer/response of another person (a virtual person); the acknowledgment skill indicating the skill of accepting and acknowledging the answer/response of the other person; and the questioning skill indicating the skill of asking open questions and the skill of questioning. Moreover, in the dialogue skill analysis device 50, based on the attentive listening skill, the acknowledgment skill, and the questioning skill as calculated by the dialogue data analyzing unit 52, the contrasting skill determining unit 53 quantifies the attentive listening skill, the acknowledgment skill, and the questioning skill. Then, in the dialogue skill analysis device 50, the analysis result output unit 55 generates information indicating the analysis result regarding the attentive listening skill, the acknowledgment skill, and the questioning skill that are quantified by the contrasting skill determining unit 53; and sends the generated information to the user terminal 10 via the communication processing unit 59.

### Step S65

In the user terminal 10, the output unit 12 displays the analysis result regarding the quantified attentive listening skill, the quantified acknowledgment skill, the quantified questioning skill as received from the dialogue skill analysis device 50.

In this way, in the dialogue training system 1, at the same time when the user conducts a quasi-dialogue with the virtual person; the skills related to the dialogue can be analyzed using the utterance details and the behavior of the user during the dialogue training as the data, and the feedback about the analysis result regarding the dialogue can be given to the user after the end of the dialogue training.

As explained above, in the dialogue skill analysis device 50 according to the present embodiment, during a dialogue in which an answer to the voice data of the utterances made by the user is given by outputting a voice using the video of the virtual person that is generated based on the information related to the target person assumed to conduct the dialogue, the dialogue data obtaining unit 51 obtains the voice data and the video data of the user as input in the user terminal 10, and the dialogue data analyzing unit 52 analyzes the dialogue skills of the user with respect to the virtual person based on the voice data and the video data obtained by the dialogue data obtaining unit 51. As a result, without having to give extra consideration to the privacy, the dialogue skills can be analyzed regardless of the dialogue details. Besides, it also becomes possible to resolve the following problems: the problem that, without receiving any dialogue training for acquiring the dialogue skills mainly via classroom lectures, acquiring the dialogue skills while having an actual dialogue is a difficult task; the problem that the adjustment of schedule with the dialogue partner takes time and effort; the problem that the person playing the role of a subordinate during the dialogue training starts to feel shy and tends to talk with reserve, thereby making it difficult to carry out the training in earnest; and the problem that, when a large number of students undergo the training, sufficient guidance about role playing cannot be provided due to the time constraint, thereby making it difficult for the instructor to handle the situation.

Moreover, in the dialogue skill analysis device 50 according to the present embodiment, the analysis result output unit 55 displays the analysis result, which is obtained by the dialogue data analyzing unit 52 and the contrasting skill determining unit 53, in the user terminal 10. As a result, the user not only undergoes the dialogue training but also becomes able to receive feedback about the dialogue skills. Hence, it becomes possible for the user to recognize the existing dialogue skills and improve on them.

Furthermore, in the dialogue skill analysis device 50 according to the present embodiment, based on the voice data and the video data obtained by the dialogue data obtaining unit 51, the emotion data analyzing unit 54 analyzes the emotions of the user during the dialogue with the virtual person. Then, based on the voice data and the emotions of the user, during the dialogue with the virtual person conducted using a video that is generated to output a voice as an answer to the concerned voice data, the dialogue data obtaining unit 51 obtains the concerned voice data and the video data. As a result, a dialogue having a greater sense of reality can be conducted with the virtual person mapped to the target person.

In the embodiment described above, when at least some of the functions of the memory management device 20, the virtual person generation device 30, the video generation device 40, and the dialogue skill analysis device 50 are to be implemented by executing computer programs, the computer programs are stored in advance in a ROM. Alternatively, in the embodiment described above, the computer programs executed in the memory management device 20, the virtual person generation device 30, the video generation device 40, and the dialogue skill analysis device 50 can be recorded as installable files or executable files in a computer-readable recording medium such as a computer disc read only memory (CD-ROM), a flexible disk (FD), a compact disk recordable (CD-R), or a digital versatile disc (DVD). Still alternatively, in the embodiment described above, the computer programs executed in the memory management device 20, the virtual person generation device 30, the video generation device 40, and the dialogue skill analysis device 50 can be stored in a downloadable manner in a computer connected to a network such as the Internet. Still alternatively, in the embodiment described above, the computer programs executed in the memory management device 20, the virtual person generation device 30, the video generation device 40, and the dialogue skill analysis device 50 can be distributed via a network such as the Internet. In the embodiment described above, the computer programs executed in the memory management device 20, the virtual person generation device 30, the video generation device 40, and the dialogue skill analysis device 50 are configured as modules including at least some of the functions explained earlier. As far as the actual hardware is concerned, a CPU reads a computer program from a memory device and executes it, so that the corresponding functional units are loaded and generated in the main memory device.

According to an embodiment, without having to give extra consideration to the privacy, the dialogue skills can be analyzed regardless of the dialogue details.

Explained below are the aspects of the present invention.
<1> A dialogue training device including:
   an obtaining unit configured to, during a dialogue in which a voice of an answer to voice data of an utterance made by a user is output using a video of a virtual person generated based on information related to a target person assumed to conduct the dialogue, obtain the voice data and video data of the user input into a terminal device; and a first analyzing unit configured to, based on the voice data and the video data obtained by the obtaining unit, analyze a dialogue skill with the virtual person.
<2> The dialogue training device according to <1>, wherein the first analyzing unit includes:
   an image analyzing unit configured to analyze behavior of the user with respect to the virtual person from the video data obtained by the obtaining unit, and analyze the dialogue skill based on the behavior; and
   a voice analyzing unit configured to analyze an answer given by the user to the virtual person from the voice data obtained by the obtaining unit, and analyze the dialogue skill based on the answer.
<3> The dialogue training device according to <2>, wherein
   the image analyzing unit is configured to analyze, as the behavior, at least any of a number of times nodding to the virtual person is performed, and a number of times smiling at the virtual person is performed, and
   the voice analyzing unit is configured to analyze, as the answer, at least any of a number of times a positive reception to the virtual person is made, a number of times a concern for the virtual person is made, a number of times a supportive response to the virtual person is made, a number of times an open question to the virtual person is made, and an utterance ratio during the dialogue with the virtual person.
<4> The dialogue training device according to any one of <1> to <3>, wherein the first analyzing unit is configured to, based on the voice data and the video data obtained by the obtaining unit, analyze at least any of an attentive listening skill, an acknowledgment skill, and a questioning skill as the dialogue skill.
<5> The dialogue training device according to any one of <1> to <4>, further including an output unit configured to cause the terminal device to display an analysis result by the first analyzing unit.
<6> The dialogue training device according to <5>, wherein
   the first analyzing unit is configured to quantify the dialogue skill, and
   the output unit is configured to cause the terminal device to display a value of the dialogue skill quantified by the first analyzing unit, as the analysis result.
<7> The dialogue training device according to <5>, wherein the output unit is configured to:
   convert the voice data into a text; and
   cause the terminal device to display the text in which a portion having contribution from the dialogue skill is highlighted, as the analysis result.
<8> The dialogue training device according to any one of <1> to <7>, further including a second analyzing unit configured to, based on the voice data and the video data obtained by the obtaining unit, analyze an emotion of the user during the dialogue with the virtual person, wherein
   the obtaining unit is configured to obtain the voice data and the video data during the dialogue with the virtual person using the video generated for outputting the voice of the answer to the voice data based on the voice data and the emotion of the user.
<9> A dialogue training system including:
   the dialogue training device according to any one of <1> to <8>;
   a first generation device configured to, based on information related to the target person, generate data of the virtual person mapped to the target person; and
   a second generation device configured to, based on the data of the virtual person generated by the first generation device, generate a video of the virtual person.
<10> A dialogue training method including:
   during a dialogue in which a voice of an answer to voice data of an utterance made by a user is output using a video of a virtual person generated based on information related to a target person assumed to conduct the dialogue, obtaining the voice data and video data of the user input into a terminal device; and
   analyzing a dialogue skill with the virtual person based on the obtained voice data and the obtained video data.
<11> A program that cause a computer to execute:
   during a dialogue in which a voice of an answer to voice data of an utterance made by a user is output using a video of a virtual person generated based on information related to a target person assumed to conduct the dialogue, obtaining the voice data and video data of the user input into a terminal device; and
   analyzing a dialogue skill with the virtual person based on the obtained voice data and the obtained video data.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A dialogue training device comprising:
an obtaining unit configured to, during a dialogue in which a voice of an answer to voice data of an utterance made by a user is output using a video of a virtual person generated based on information related to a target person assumed to conduct the dialogue, obtain the voice data and video data of the user input into a terminal device; and
a first analyzing unit configured to, based on the voice data and the video data obtained by the obtaining unit, analyze a dialogue skill with the virtual person.

2. The dialogue training device according to claim 1, wherein the first analyzing unit includes:
an image analyzing unit configured to analyze behavior of the user with respect to the virtual person from the video data obtained by the obtaining unit, and analyze the dialogue skill based on the behavior; and
a voice analyzing unit configured to analyze an answer given by the user to the virtual person from the voice data obtained by the obtaining unit, and analyze the dialogue skill based on the answer.

3. The dialogue training device according to claim 2, wherein
the image analyzing unit is configured to analyze, as the behavior, at least any of a number of times nodding to the virtual person is performed, and a number of times smiling at the virtual person is performed, and
the voice analyzing unit is configured to analyze, as the answer, at least any of a number of times a positive reception to the virtual person is made, a number of times a concern for the virtual person is made, a number of times a supportive response to the virtual person is made, a number of times an open question to the virtual person is made, and an utterance ratio during the dialogue with the virtual person.

4. The dialogue training device according to claim 1, wherein the first analyzing unit is configured to, based on the voice data and the video data obtained by the obtaining unit, analyze at least any of an attentive listening skill, an acknowledgment skill, and a questioning skill as the dialogue skill.

5. The dialogue training device according to claim 1, further comprising an output unit configured to cause the terminal device to display an analysis result by the first analyzing unit.

6. The dialogue training device according to claim 5, wherein
the first analyzing unit is configured to quantify the dialogue skill, and
the output unit is configured to cause the terminal device to display a value of the dialogue skill quantified by the first analyzing unit, as the analysis result.

7. The dialogue training device according to claim 5, wherein the output unit is configured to:
convert the voice data into a text; and
cause the terminal device to display the text in which a portion having contribution from the dialogue skill is highlighted, as the analysis result.

8. The dialogue training device according to claim 1, further comprising a second analyzing unit configured to, based on the voice data and the video data obtained by the obtaining unit, analyze an emotion of the user during the dialogue with the virtual person, wherein
the obtaining unit is configured to obtain the voice data and the video data during the dialogue with the virtual person using the video generated for outputting the voice of the answer to the voice data based on the voice data and the emotion of the user.

9. A dialogue training system comprising:
the dialogue training device according to claim 1;
a first generation device configured to, based on information related to the target person, generate data of the virtual person mapped to the target person; and
a second generation device configured to, based on the data of the virtual person generated by the first generation device, generate a video of the virtual person.

10. A dialogue training method comprising:
during a dialogue in which a voice of an answer to voice data of an utterance made by a user is output using a video of a virtual person generated based on information related to a target person assumed to conduct the dialogue, obtaining the voice data and video data of the user input into a terminal device; and
analyzing a dialogue skill with the virtual person based on the obtained voice data and the obtained video data.

11. A non-transitory computer-readable medium including programmed instructions that cause a computer to execute:
during a dialogue in which a voice of an answer to voice data of an utterance made by a user is output using a video of a virtual person generated based on information related to a target person assumed to conduct the dialogue, obtaining the voice data and video data of the user input into a terminal device; and
analyzing a dialogue skill with the virtual person based on the obtained voice data and the obtained video data.
